(19) United States
(12) Patent Application Publication
(10) Pub. No.: US 2008/0128283 A1
(43) Pub. Date: Jun. 5, 2008

(54) Water Purification Apparatus

(76) Inventor: Adriaan Hendrik Janse Van Rensburg, Ruimsig, CA (US)

Correspondence Address: HAHN AND MOODLEY, LLP, P.O. BOX 52050, MINNEAPOLIS, MN, 55402, US

(21) Appl. No.: 11/569,573

(22) PCT Filed: May 23, 2005
(86) PCT No.: PCT/ZA05/00072

§ 371 Date: Sep. 18, 2007

(30) Foreign Application Priority Data
May 24, 2004 (ZA) 2004/0859

(51) Int. Cl. C02F 1/48

(52) U.S. Cl. 204/661; 204/663

(57) ABSTRACT

A water purification apparatus (10) which includes at least one emitter (12) and a processor (14). The emitter (12) is for emitting an electromagnetic wave having a specific frequency through water (14), with the emitter (12) also being configured to propagate the emitted wave through water (14). The processor (16) is arranged in communication with the emitter (12) which processor (16) is configured to automatically regulate a frequency of the electromagnetic wave emitted by the emitter (12) so that the specific frequency or harmonic components of said wave is similar to a resonant frequency of a particular impurity typically found in water (14) in an attempt to destroy the impurity.

### FIELD OF THE INVENTION

This invention relates to water purification apparatus, and to an associated method for water purification.

### BACKGROUND TO THE INVENTION

The Inventor has identified problems which exist where chemicals are used in water purification. One problem is that specific chemicals must be used which are typically dangerous and often require special handling and storage precautions.

A second problem is present in applications where only specific impurities must be removed from water, for example in sewage treatment where the use of chemicals will destroy desirable organisms, or brewing vats, or the like.

A third problem is found in the fact that the chemicals must generally be further removed from the water due to the fact that the chemicals are generally harmful to humans, plants, and animals.

### SUMMARY OF THE INVENTION

According to one aspect of the invention there is provided a water purification apparatus which includes at least one emitter for emitting an electromagnetic wave having a specific frequency, wherein the emitter is configured to propagate the emitted wave through water; and

a processor arranged in communication with the emitter which processor is configured to automatically regulate a frequency of the electromagnetic wave emitted by the emitter so that the specific frequency or harmonic components of said wave is similar to a resonant frequency of a particular impurity typically found in water, in an attempt to destroy the impurity.

The impurity may include algae. The impurity may include bacteria. The impurity may include pathogens. The impurity may include viruses. The impurity may include fungi. The impurity may include protozoa. It is to be appreciated that the impurity may include any type of matter or substance.

The processor may be programmed with a range of frequencies wherein each particular frequency conforms to a resonant frequency of a specific impurity.

Accordingly, the processor may automatically regulate the transmitter to sequentially emit all programmed frequencies in the programmed range of frequencies. Otherwise, the processor may be configured to regulate the emitter to emit a particular frequency in the programmed range according to a request received from a user.

The emitter may be configured to propagate the wave through water by being positioned in a water carrying channel, e.g. a pipe, a tube, or any similar conduit. Otherwise, the emitter may be housed in a housing for submersion in water. Accordingly, the emitter may include a coil arrangement for placement in the water. Similarly, the emitter may include an electrode for placement in the water, or the like.

The apparatus may include a sensor for sensing at least one particular impurity in water, i.e. to determine what types of impurities are present in water. Accordingly, the sensor may include an optical sensor to determine the clarity of water which clarity indicates certain types of impurities, e.g. algae, or the like. The sensor may sense the presence of biological material in water, e.g. pathogens, bacteria, viruses, and/or the like. The sensor may sense temperature of water which temperature is conducive to sustaining particular impurities. The sensor may sense a pH value of water which pH value is conducive to sustaining particular impurities.

Accordingly, the processor may be configured to emit a wave with a specific frequency conforming to a resonant frequency of a particular sensed impurity.

The apparatus may include an enclosure which includes attachment means for attaching the apparatus to an existing water pipe, e.g. typically the enclosure will have compression glands for attaching the apparatus to a pipe, a channel, and/or the like.

The apparatus may be installed to purify water in a recreational application. Accordingly, the apparatus may be installed to purify water in a swimming pool. The apparatus may be installed to purify water in a Jacuzzi, a hot tub, or the like.

The apparatus may be connected to a mains water supply which supplies water to a consumer. Accordingly, the consumer may include a residential, commercial, and/or industrial consumer.

The apparatus may be used to purify water before the water is returned to a general circulation system, e.g. before the water is allowed to enter the conventional recycling system.

According to a second aspect of the invention there is provided a method for water purification which method includes the step of emitting an electromagnetic wave into water, which wave has a specific frequency which frequency or harmonic components thereof is similar to a resonant frequency of a particular impurity typically found in water, in an attempt to destroy the impurity.

It is to be appreciated that, by submitting an impurity to its resonant frequency, i.e. natural frequency, chemical bonds between elements of the impurity are destroyed which leads to the destruction of the impurity.

The impurity typically includes bacteria, pathogens, algae, viruses, fungi, protozoa, and/or the like.

The step of emitting may include sequentially emitting a range of frequencies wherein each particular frequency conforms to a resonant frequency of a specific impurity.

The method may include the step of sensing impurities in water, i.e. to determine what types of impurities are present in water. Accordingly, the step of sensing may include sensing the clarity of water which clarity indicates certain types of impurities, e.g. algae, or the like. The step of sensing may include sensing the presence of biological material in water, e.g. pathogens, bacteria, viruses, and/or the like. The step of sensing may include sensing a temperature of water which temperature is conducive for sustaining a particular impurity. The step of sensing may include sensing a pH value of water, which pH value is conducive to sustaining a particular impurity.

Accordingly, the step of emitting may include emitting a wave with a specific frequency conforming to a resonant frequency of a sensed impurity.

The method may include the step of installing a suitable apparatus for purifying water in a recreational application. Accordingly, the apparatus may be installed to purify water in a swimming pool. The apparatus may be installed to purify water in a Jacuzzi. The apparatus may be used to purify water supplied to a consumer. The consumer may include a residential, commercial, and/or industrial consumer.

### BRIEF DESCRIPTION OF THE DRAWINGS

The invention is now described, by way of non-limiting example, with reference to the accompanying drawings wherein

FIG. 1 shows, in perspective view, a water purification apparatus, in accordance with the invention; and

FIG. 2 shows, in perspective view, a further embodiment of the water purification apparatus, according to the invention.

### DETAILED DESCRIPTION OF THE INVENTION

With reference to the accompanying drawings, a water purification apparatus, in accordance with the invention, is generally indicated by reference numeral 10.

The water purification apparatus 10 includes at least one emitter 12 and a processor 14.

The emitter 12 is for emitting an electromagnetic wave having a specific frequency through water 14, the emitter 12 being configured to propagate the emitted wave through water 14.

The processor 16 is arranged in communication with the emitter 12 which processor 16 is configured to automatically regulate a frequency of the electromagnetic wave emitted by the emitter 12 so that the specific frequency of said wave is similar to a resonant frequency of a particular impurity typically found in water 14 in an attempt to destroy the impurity.

The impurity typically includes algae, bacteria, pathogens, viruses, fungi, protozoa, and/or the like. The impurity can also include a non-organic substance.

The processor 16 is programmed with a range of frequencies wherein each particular frequency conforms to a resonant frequency of a specific impurity.

Accordingly, the processor 16 then automatically regulates the emitter 12 to sequentially emit all programmed frequencies in the programmed range of frequencies. In a further embodiment, the processor 16 is configured to regulate the emitter 12 to emit a particular frequency in the programmed range according to a request received from a user, e.g. via a terminal, an input, or the like.

For example, the following is a list of resonant frequencies and the impurities which they target, respectively:

| | |
|---|---|
| 129 kHz | Lycogala, Sterigmatocystin |
| 185 kHz | Aflatoxin |
| 256 kHz | Blue Green Algae |
| 296 kHz | Ergot, Histoplasma, |
| 316 kHz | Corynebacterium, |
| 326 kHz | Influenza, Bacteriodes, Proteus mirabilis |
| 354 kHz | Naegleria, Nocardia, Diploccus, |
| 362 kHz | Besnoitia, Loa loa, Naegleria, Bacillus, Diplococcus |
| 368 kHz | Streptococcus, Salmonella, |
| 382 kHz | Borellia, Trichomomas, Gyrodactylus, Haemoproteus, Micrococcus, |
| | Spirillum, Staphyloccus, Syncytial virus, Eikanella |
| 386 kHz | Anaplasma, Haemonchus, Salmonella, Clostridium, Adenovirus, Alpha |
| | Streptoccus, Beta Strep, Candida, Propionobacterium |
| 392 kHz | E. Coli |
| 395 kHz | Escherichia, Shigella |
| 401 kHz | Trichinella, Strongyloides, Klebsiella, Lodamoeba, Leischmania, |
| | Leucocytozoon, Entamaeba, Ancylostoma, Leptospira, Chilomonas, |
| | Prosthogonimus |
| 405 kHz | Ascaris, Dientamoeba, Pneumocyctis, Proteus vulgaris, Cytomegalovirus, |
| | Stigeoclonium, Trichinella, Trichurus, Blepharisma |
| 418 kHz | Plasmodium cynomolgi, Eurytrema, Echinporyphium, Enterobius, |
| | Faxciola, Troglodytella, Hepatitus, |
| 424 kHz | Gardia |
| 428 kHz | Capillaria, Chilomastix, Clonorchis, Echinostoma, jFasciola, Fasciolopsis, |
| | Hypodereum, Trypauasoma |
| 433 kHz | Cytophaga, Trypanasoma, Moniezia, Fasciolopsis, Endamoeba, |
| | Endolimax, Mycobacterium |
| 442 kHz | Cysticercus, Macracanthorhynchus, Dipylidium, Echinococcus, |
| | Endamoeba, Fischoedrius, Lodamoeba, Metagonimus, Onchocerca, |
| | Paragonimus, Passalurus, Plasmodium vivax. |

It is to be appreciated that the above list in no way represents an exhaustive list of frequencies and related impurities. It is further to be appreciated that the harmonic components of these frequencies may also facilitate with destroying the different impurities.

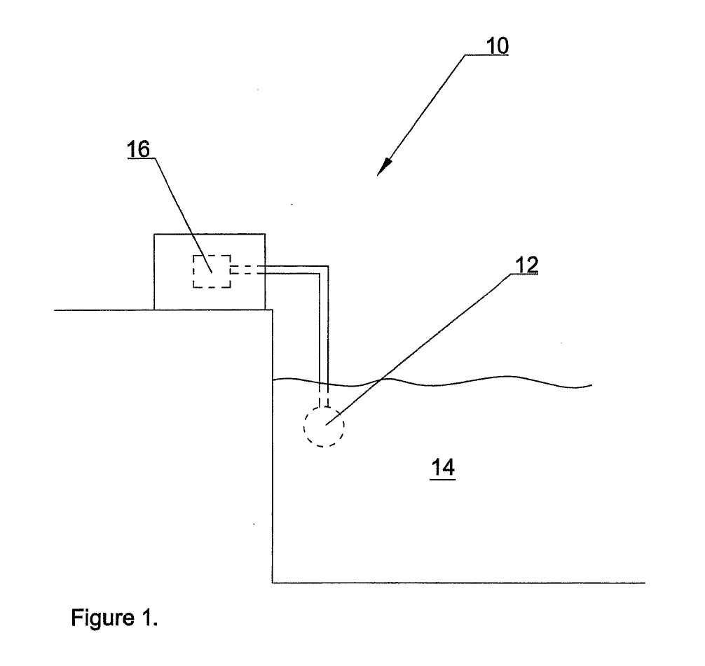

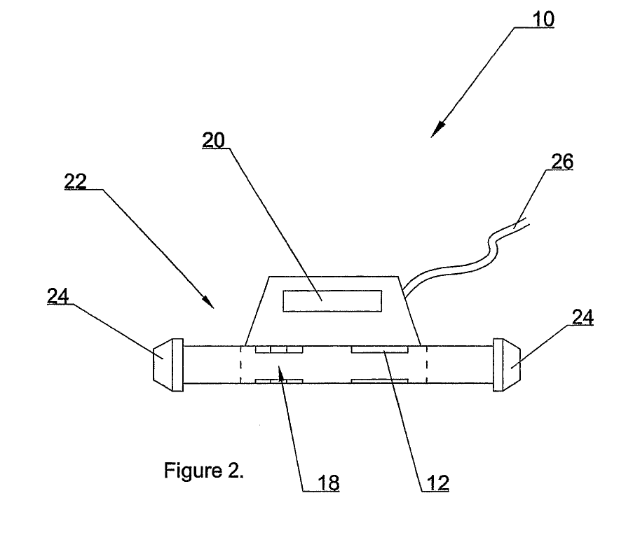

FIG. 2 shows the emitter 12 being configured to propagate the wave through water 14 by being positioned in a water carrying channel, e.g. a pipe, a tube, or any similar conduit. FIG. 1 shows the emitter 12 housed in a housing for submersion in water 14. Accordingly, the emitter 12 may include a coil arrangement for placement in the water 14, an electrode for placement in the water 14, or the like. It is to be appreciated that the emitter 12 may also include at least one magnet for generating a magnetic wave propagated through water 14.

In a preferred embodiment of the invention, the apparatus 10 includes a sensor 18 for sensing impurities in water, i.e. to determine what types of impurities are present in water. Accordingly, the sensor 18 includes an optical sensor to determine the clarity of water which clarity indicates certain types of impurities, e.g. algae, or the like.

In further embodiments, the sensor 18 also senses the presence of biological material in water, e.g. pathogens, bacteria, viruses, and/or the like. The sensor 18 also senses temperature of water, a pH value of water, and/or the like.

Accordingly, the processor 16 is then configured to only emit a wave with a specific frequency conforming to a resonant frequency of a sensed impurity, i.e. only targets the sensed impurity.

FIG. 2 shows the apparatus 10 which includes an enclosure 22 with attachment means 24 for attaching the apparatus 10 to an existing water conduit, e.g. the enclosure 22 has compression glands 24 for attaching an inlet and outlet of the apparatus 10 to a pipe, or the like. The enclosure 22 houses the emitter 12 and sensor, if required.

The Invention further extends to a corresponding method for water purification which method includes the step of emitting an electromagnetic wave into water 14 which wave has a specific frequency which is similar to a resonant frequency of a particular impurity typically found in water in an attempt to destroy the impurity.

The impurity typically includes algae, bacteria, pathogens, algae, viruses, fungi, protozoa, and/or the like.

In one embodiment, the step of emitting includes sequentially emitting a range of frequencies wherein each particular frequency conforms to a resonant frequency of a specific impurity.

In a further embodiment, the method includes the step of sensing impurities in water, i.e. to determine what types of impurities are present in water. Accordingly, the step of sensing may include sensing the clarity of water which clarity indicates certain types of impurities, e.g. algae, or the like, sensing the presence of biological material in water, e.g. pathogens, bacteria, viruses, and/or the like, sensing a temperature of water, sensing a pH value of water, and/or the like.

Accordingly, the step of emitting then typically includes only emitting a wave with a specific frequency conforming to a resonant frequency of a sensed impurity.

It is to be appreciated that the emitter 12 is typically capable of producing pulsed, modulated and/or continues resonant frequencies with a resolution of better than 0.004 in the range of 1 to 2 MHz without any frequency drift.

The embodiment shown in FIG. 2 also includes a display 20 for showing the operation of the apparatus 10, e.g. measured impurities, water temperature, pH level, current frequency emitted, and/or the like. The enclosure 22 also includes an external electronic connection 26 for communication with a remote computer (not shown).

It is to be appreciated that the apparatus 10 is usable in a host of applications, e.g. removing algae and other impurities from a swimming pool, purifying water for drinking purposes, cleaning water in spas and hot tubs, treatment of sewage, and/or the like. As different types of impurities are typically found in different applications, the apparatus 10 will emit electromagnetic waves of different frequencies to target the specific impurities.

The apparatus 10 can also be used to purify water returning to a general circulation system after use by a consumer.

It is further to be appreciated that the apparatus 10 is also usable to destroy impurities on objects immersed in water, as the electromagnetic waves emitted by the emitter 12 will also destroy the impurities on these objects, e.g. fungi on fruit being washed, or the like.

It shall be understood that the examples are provided for illustrating the invention further and to assist a person skilled in the art with understanding the invention and is not meant to be construed as unduly limiting the reasonable scope of the invention.

The inventor regards it as an advantage that the invention provides for a way to purify water without requiring chemicals. The Inventor regards it as a further advantage that the invention facilitates the destruction of specific impurities in water.

1-47. (canceled)

48. A water purification apparatus which includes
at least one emitter for emitting an electromagnetic wave having a specific frequency, wherein the emitter is configured to propagate the emitted weave through water; and
a processor arranged in communication with the emitter which processor is configured to automatically regulate a frequency of the electromagnetic wave emitted by the emitter so that the specific frequency or harmonic components of said weave is similar to a resonant frequency of a particular impurity typically found in water, in an attempt to destroy the impurity.

49. An apparatus as claimed in claim 48, wherein the impurity includes algae.

50. An apparatus as claimed in claim 48, wherein the impurity includes bacteria.

51. An apparatus as claimed in claim 48, wherein the impurity includes a pathogen.

52. An apparatus as claimed in claim 48, wherein the impurity includes a virus.

53. An apparatus as claimed in claim 48, wherein the impurity includes a fungus.

54. An apparatus as claimed in claim 48, wherein the impurity includes a protozoon.

55. An apparatus as claimed in claim 48, wherein the processor is programmed with a range of frequencies wherein each particular frequency conforms to a resonant frequency of a specific impurity.

56. An apparatus as claimed in claim 55, wherein the processor automatically regulates the emitter, in use, to sequentially emit all programmed frequencies in the programmed range of frequencies.

57. An apparatus as claimed in claim 55, wherein the processor regulates the emitter to emit a particular frequency in the programmed range according to a request received from a user which selects a particular frequency.

58. An apparatus as claimed in claim 48, wherein the emitter is configured to propagate the wave through water by being positioned in a water carrying channel.

59. An apparatus as claimed in claim 48, wherein the emitter is housed in a housing for submersion in water.

60. An apparatus as claimed in claim 48 which includes a sensor for sensing at least one particular impurity in water.

61. An apparatus as claimed in claim 60, wherein the sensor includes an optical sensor to determine the clarity of water which clarity, is indicative of a particular type of impurity in the water.

62. An apparatus as claimed in claim 60, wherein the sensor includes a temperature sensor for sensing a temperature of the water which temperature is conducive to sustaining a particular impurity.

63. An apparatus as claimed in claim 60, wherein the sensor includes a pH sensor for sensing a pH value of the water which pH value is conductive for sustaining a particular impurity.

64. An apparatus as claimed in claim 60, wherein the processor is configured to emit a wave with a specific frequency conforming to a resonant frequency of a particular sensed impurity.

65. An apparatus as claimed in claim 48, which includes an enclosure with attachment means for attaching the apparatus to an existing water pipe.
